(19) United States
(12) Patent Application Publication
(10) Pub. No.: US 2026/0228986 A1
(43) Pub. Date: Aug. 6, 2026

(54) METHOD AND APPARATUS FOR INTERACTION IN VIRTUAL ENVIRONMENT, DEVICE AND STORAGE MEDIUM

(71) Applicant: Beijing Zitiao Network Technology Co., Ltd., Beijing (CN)

(72) Inventors: Chao Zhou, Beijing (CN); Dong You, Beijing (CN); Jiawei Li, Beijing (CN); Xinglun Liang, Beijing (CN); Fan Zhang, Beijing (CN); Yepeng Chen, Beijing (CN); Zhiwei Su, Beijing (CN); Lei Gao, Beijing (CN)

(21) Appl. No.: 19/159,141

(22) PCT Filed: Feb. 20, 2024
(86) PCT No.: PCT/CN2024/077823

§ 371 Date: Aug. 22, 2025

(30) Foreign Application Priority Data
Feb. 23, 2023 (CN) 202310189738.6

(51) Int. Cl. G06T 19/00; G06F 3/04815; G06F 3/04842

(52) U.S. Cl. CPC G06T 19/006; G06F 3/04815; G06F 3/04842

(57) ABSTRACT

According to embodiments of the present disclosure, a method and apparatus for interaction in a virtual environment, a device and a storage medium are provided. The method includes presenting in the virtual environment an image of a real object in a real world and representations of a group of virtual objects, the representations including at least images of corresponding virtual objects; detecting a selection, by a user, of a first virtual object from the group of virtual objects; in response to detecting the selection, presenting a composite image of the real object and the first virtual object in the virtual environment; and in response to receiving a first input from a user, associating the first virtual object with the user. In this way, a user can implement behaviors that are usually performed in the real world in the virtual environment, thereby enriching the diversity of the interaction processes that the user can perform in the virtual environment, and improving the user's interaction experience.

This application is the U.S. National Stage of International Application No. PCT/CN2024/077823, filed on Feb. 20, 2024, which claims priority to Chinese invention patent application No. 202310189738.6 entitled “METHOD AND APPARATUS FOR INTERACTION IN VIRTUAL ENVIRONMENT, DEVICE AND STORAGE MEDIUM” filed on Feb. 23, 2023, which is incorporated herein by reference in its entirety.

### FIELD

Example embodiments of the present disclosure generally relate to the field of computers, and in particularly, to a method and apparatus for interaction in a virtual environment, a device and a storage medium.

### BACKGROUND

In recent years, virtual reality (referred to as VR), augmented reality (referred to as AR) and other technologies have been widely studied and applied. By combining hardware devices and a variety of technical means, virtual content and real scenes are integrated to provide users with unique sensory experience. VR is the use of a computer to simulate a virtual world of three-dimensional space, providing users with an immersive experience in vision, hearing, touch, etc. AR allows the real environment and virtual objects to be overlapped in the same space in real time and exist simultaneously.

### SUMMARY

In a first aspect of the present disclosure, a method for interaction in a virtual environment is provided. The method includes: presenting in the virtual environment an image of a real object in a real world and representations of a group of virtual objects, the representations including at least images of corresponding virtual objects; detecting a selection, by a user, of a first virtual object from the group of virtual objects; in response to detecting the selection, presenting a composite image of the real object and the first virtual object in the virtual environment; and in response to receiving a first input from a user, associating the first virtual object with the user.

In a second aspect of the present disclosure, an apparatus for interaction in a virtual environment is provided. The apparatus includes a first presentation module configured to present in the virtual environment: an image of a real object in a real world, and representations of a group of virtual objects, the representations including at least images of corresponding virtual objects; a detection module configured to detect a selection, by a user, of a first virtual object from the group of virtual objects; a second presentation module configured to present a composite image of the real object and the first virtual object in the virtual environment in response to detecting the selection; and an association module configured to associate the first virtual object with a user in response to receiving a first input from the user.

In a third aspect of the present disclosure, an electronic device is provided. The device includes at least one processor; and at least one memory coupled to the at least one processor and storing instructions executed by the at least one processor. The instructions, when executed by the at least one processor, cause the device to execute the method in the first aspect.

In a fourth aspect of the present disclosure, a computer-readable storage medium is provided, wherein a computer program is stored in the computer-readable storage medium, and the computer program, when executed by a processor, implements the method in the first aspect.

It should be understood that the content described in the Summary section of the present invention is not intended to limit the key features or important features of the embodiments of the present disclosure, nor is they intended to limit the scope of the present disclosure. Other features of the present disclosure will become easily understood through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the accompanying drawings, the same or similar reference symbols refer to the same or similar elements, in which:

FIG. 1 shows a block diagram of an environment according to some embodiments of the present disclosure;

FIG. 2 shows a flowchart of an example process for interaction in a virtual environment according to some embodiments of the present disclosure;

FIGS. 3A and 3B show schematic diagrams of virtual scenes according to some embodiments of the present disclosure;

FIG. 4 shows a block diagram of an example interactive system in a virtual environment according to some embodiments of the present disclosure;

FIG. 5 shows a block diagram of an apparatus for interaction in a virtual environment according to some embodiments of the present disclosure; and

FIG. 6 shows a block diagram of a device capable of implementing various embodiments of the present disclosure.

### DETAILED DESCRIPTION

The following describes embodiments of the present disclosure in detail with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided for more thorough and complete understanding of the present disclosure. It should be understood that the accompanying drawings and embodiments of the present disclosure are merely used for the purpose of illustration, but are not intended to limit the protection scope of the present disclosure.

In descriptions of embodiments of the present disclosure, the term “include” and similar terms thereof should be understood as open inclusion, that is, “include but is not limited to”. The term “based on” should be understood as “at least partially based on”. The terms “one embodiment” or “the embodiment” should be understood as “at least one embodiment.” The term “some embodiments” should be understood as “at least some embodiments.” Other explicit and implicit definitions may also be included below.

In the description of the embodiments of the present disclosure, the term “virtual environment” includes but is not limited to “VR”, “AR”, etc. It should be understood that the term “virtual environment” can be any one of “VR” and “AR”, or any combination thereof. In the following description, for the sake of convenience of description only, the “virtual environment” is used in the embodiments of the present disclosure to represent one or more of “VR” and “AR”, or any combination thereof.

In some embodiments below, the virtual environment may involve a virtual shopping mall, which may be used as an example application scenario for a user to perform an interactive process. However, it should be understood that the above example application scenario should not be understood as a limitation on the present disclosure. In fact, the interactive process, such as the process of selecting a virtual object, may be implemented via a user's request in any appropriate application scenario. The present disclosure is not limited in this respect.

The term “in response to” means that the corresponding event occurs or the condition is satisfied. It will be understood that the execution time of a subsequent action executed in response to the event or condition is not necessarily strongly related to the time when the event occurs or the condition is satisfied. In some cases, the subsequent action may be executed immediately when the event occurs or the condition is satisfied, while in other cases, the subsequent action may be executed after the event occurs or the condition is satisfied for a period of time.

It may be understood that data involved in this technical solution (including, but not limited to, the data itself, and the acquisition or use of the data) shall comply with the requirements of the corresponding laws and regulations and relevant provisions.

It may be understood that before using the technical solutions disclosed in the embodiments of the present disclosure, a user should be informed of the type, the scope of use, the use scenario, and the like of personal information involved in the present disclosure in accordance with the relevant laws and regulations, and the user's authorization should be obtained in appropriate fashions.

At present, due to the rise of VR and AR technologies, users' social needs in the virtual environment provided by VR and/or AR are becoming increasingly clear. These users hope to build their own second home in the virtual environment, in which they can not only communicate and interact with other users, but also realize behaviors in daily life, such as entertainment and shopping.

In view of this, embodiments of the present disclosure provide a scheme for interaction in a virtual environment. In this scheme, an image of a real object in a real world and representations of a group of virtual objects, such as an image of a virtual object can be presented in a virtual environment; if a user's selection of the virtual object is detected, a composite image of the real object and the selected virtual object is presented in the virtual environment; if a specific operation input by a user is received, the real object is associated with the user. In this way, the user can implement behaviors that are usually performed in the real world in the virtual environment, enriching the diversity of the interactive processes that the user can perform in the virtual environment and improving the user's interactive experience.

Example embodiments of the present disclosure are described below with reference to the accompanying drawings.

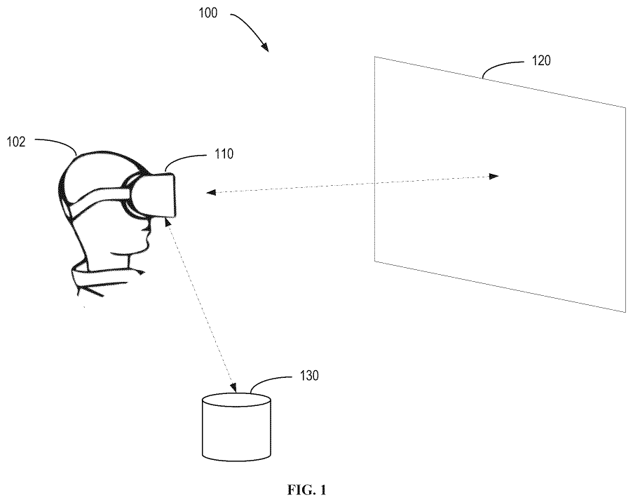

FIG. 1 shows a schematic diagram of an example environment 100 in which embodiments of the present disclosure can be implemented. The example environment 100 includes a user 102 and his/her user equipment 110. In the example environment 100, the user equipment 110 has an application (hereinafter referred to as a control module) installed and running to support a virtual environment, thereby supporting the presentation of a virtual environment 120 at the user equipment 110 or by the user equipment 110 to the user 102.

In some embodiments, the virtual environment 120 is a VR/AR environment. As shown in FIG. 1, the user equipment 120 may be a head-mounted VR/AR device. After the user 102 wears the user equipment 110, the virtual environment 120 may be displayed for the user 102, and the virtual environment may include multiple virtual objects and representations of real objects in the real world. The virtual objects may include virtual representations corresponding to real objects in the real world and/or objects that are only applicable to the virtual environment.

Additionally, the user 102 may input instructions in the virtual environment 120 by a selection object. Specifically, a virtual selection object, such as a virtual handle and/or a virtual hand, may be presented in the virtual environment 120. In some embodiments, the virtual selection object may correspond to a physical object in the real world (e.g., a handle being operated by the user and/or the user's hand).

In some other embodiments, an image of a real object in the real world (an image of the user's hand) may be presented in the virtual environment 120 as a selection object.

In some embodiments, the virtual environment is an AR/XR environment. In this particular virtual environment, the user equipment 110 can be any type of AR/XR device, including but not limited to a mobile terminal, a fixed terminal or a portable terminal, including a mobile phone, a desktop computer, a laptop computer, a notebook computer, a netbook computer, a tablet computer, a media computer, a multimedia tablet, a gaming device, a wearable device, a personal communication system (PCS) device, a personal navigation device, a personal digital assistant (PDA), an audio/video player, a digital camera/camcorder, a positioning device, a television receiver, a radio broadcast receiver, an e-book device, or any combination of the foregoing, including accessories and peripherals of these devices or any combination thereof. In some embodiments, the user equipment 110 can also support any type of interface for the user (such as a “wearable” circuit, etc.).

As shown in FIG. 1, the environment 100 may optionally include a remote device 130, and the user equipment 110 may communicate with the remote device 130. In some embodiments, the remote device 130 may be a cloud server.

It should be understood that the remote device 130 may include at least one of one or more servers, cloud computing platforms, and virtualization centers. It should also be understood that in some embodiments, the remote device 130 is a background service that supports virtual environment applications. In some embodiments, a specific process can be implemented by the remote device 130 and the user equipment 110 in collaboration. For example, in some embodiments, the remote device 130 undertakes the main computing work and the computing device 120 undertakes the secondary computing work. Alternatively, in other embodiments, the remote device 130 undertakes the secondary computing work and the user equipment 110 undertakes the main computing work. Alternatively, in some embodiments, a specific process can be implemented independently by the remote device 130 or the user equipment 110.

In short, although in some embodiments, some operations are described as being implemented by the user equipment 110, these operations may be implemented at least in part by the remote device 130. Accordingly, although some operations are described as being implemented by the remote device 130, these operations may be implemented at least in part by the user equipment 110. For the purpose of brevity only, the same or similar descriptions will be omitted.

It should be understood that the structure and function of the environment 100 are described for illustrative purposes only and do not imply any limitation on the scope of the present disclosure.

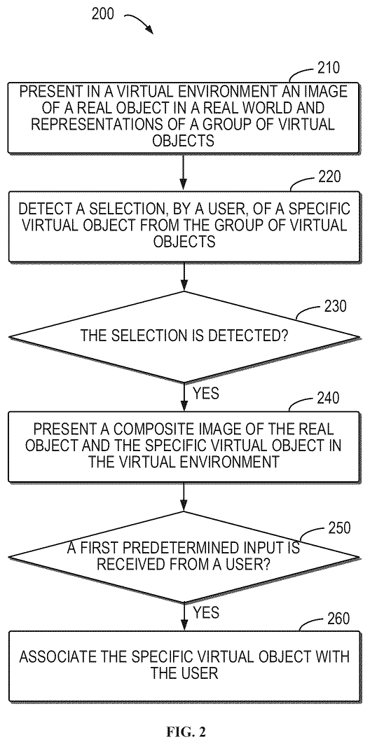

Some example embodiments of the present disclosure will be described below with reference to the accompanying drawings. FIG. 2 shows a flowchart of a method 200 for interaction in a virtual environment according to some embodiments of the present disclosure. The method 200 may be performed by the user equipment 110 in FIG. 1. For ease of discussion, the user equipment 110 is used as an example for description below. However, this is merely exemplary and does not impose any limitation on the embodiments of the present disclosure. It should be understood that the embodiments of the present disclosure may also be performed by other appropriate servers or electronic devices.

As shown in FIG. 2, at block 210, the user equipment 110 presents an image of a real object in the real world and representations of a group of virtual objects in the virtual environment 120.

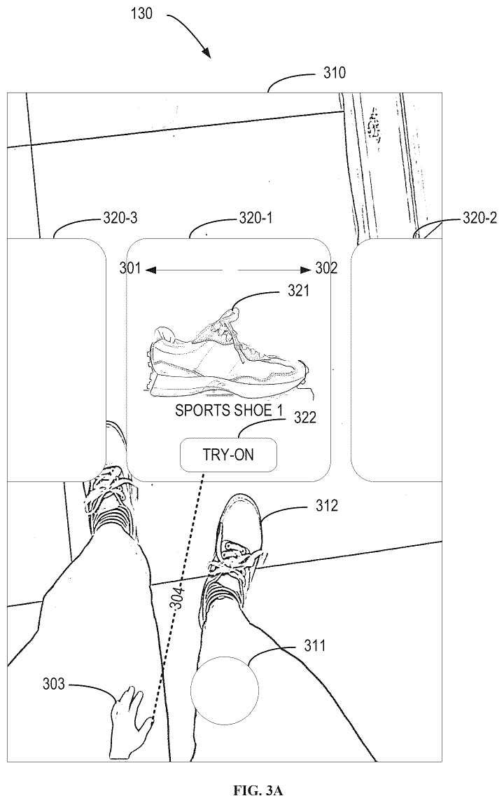

For example, in the virtual environment 120 shown in FIG. 3A, the user equipment 110 presents an image 310 in the real world. A real object 312 in the real world (e.g., the feet of the user 102) may be presented in the image 310. It should be understood that the image 310 of the real object 312 in the real world may include a static image or a dynamic image. The user 102 may capture or record the static image or the dynamic image by operating a control 311.

In the virtual environment 120 shown in FIG. 3A, the user equipment 110 also presents images 320-1, 320-2, and 320-3 of a group of virtual objects. For example, the image 320-1 is an image of a virtual object 321. The images of these virtual objects can be presented in the virtual environment 120 in a predetermined presentation style. When the user equipment 110 detects a specific operation of the user 102 (also referred to as a third input in the present disclosure), such as a sliding operation along a direction 301 or 320, presentation positions of the images of the group of virtual objects on an interface of the virtual environment 120 are switched for the user to browse, that is, an image of a current virtual object presented in the virtual environment 120 is switched to images of a next group of virtual objects. It should be understood that the number of virtual objects presented in the virtual environment 120 depends on a predetermined setting. The example shown in FIG. 3A is for illustrative purposes only and should not be used as a limitation on the scope of the present disclosure.

As an example, the virtual environment 120 presented in FIG. 3A may be a virtual shopping mall, and the images of the group of virtual objects presented may be regarded as images of virtual commodities corresponding to real commodities in the real world. For example, the image 320-1 (also referred to as a commodity card) displays the virtual commodity 321 corresponding to a real commodity in the real world. The commodity card may also display the commodity name (e.g., sports shoes 1), commodity price, promotional information, etc. of the real commodity corresponding to the virtual commodity.

At box 220, if a selection of a first virtual object 321 by the user 102 is detected, then at box 230, the user equipment 110 presents a composite image of the real object 312 and the first virtual object 321 in the virtual environment 120.

With continued reference to FIG. 3A, for example, if the user equipment 110 detects in the virtual environment 120 a selection operation by the user 102 on a control 322 (e.g., a try-on control) presented on the image 320-1 of the virtual object, the user 102 may determine that the virtual object 321 displayed on the image 320-1 of the virtual object is selected by the user 102.

Once it is determined that the virtual object 321 is selected, as shown in FIG. 3B, the user equipment 130 presents a composite image 330 of the virtual object 321 and the real object 312 in the virtual environment 120. For example, in FIG. 3B, the composite image 330 presents the effect of trying on the sports shoes 1 on the user's feet.

In this way, a virtual shopping mall scene and a corresponding simulated try-on function can be provided to the user 102 in a virtual environment. By adopting technologies such as AR/VR, the user 102 can obtain an immersive shopping experience comparable to a real try-on scene of offline shopping.

In addition, considering that users may not be willing to upload their own images for their own reasons, compared with the traditional online try-on solution, the simulated try-on function proposed in the embodiment of the present disclosure does not require users to upload their own images to the server, so it not only protects the user's data and privacy, but also makes the user feel more relaxed and comfortable when using the simulated try-on function.

Returning back to FIG. 2, at box 240, if a first input from the user 102 is received, then at box 250, the user equipment 110 associates the virtual object 321 with the user 102.

In some embodiments, the user equipment 110 may present an access for associating the virtual object 321 with the user 102. For example, as shown in FIG. 3B, a control 332 for purchasing a real object (e.g., sports shoes 1) corresponding to the virtual object 321 may be presented. As another example, for the real object corresponding to the virtual object 321, a control 333 for selecting the size of the real object may be presented. It should be understood that in some other embodiments, the user 102 may also be able to purchase the virtual object 321 itself. For example, the user 102 may use the purchased virtual object 321 for the avatar of the user 102 in the virtual environment 103 and/or a virtual object (not shown) corresponding to the user in the virtual environment 120, etc.

If the user equipment 110 detects an operation of the user 102 on the control 332 and/or the control 333 (e.g., confirming a purchase or selecting a specific size), a virtual scene in which the user can complete the association with the first virtual object may be presented. For example, a virtual scene (not shown) in which the user 102 can purchase the object may be presented in the virtual environment 120, so that the user 102 can complete the association with the virtual object 321 in the virtual scene, that is, complete the purchase or have ownership or use rights of the virtual object 321 and/or the real object corresponding to the virtual object 321.

In some embodiments, if the user equipment 110 detects a second input from the user 102, the user equipment 110 may stop presenting the composite image 330.

For example, as shown in FIG. 3B, if the user 102 of the user equipment 110 operates a control 331 (e.g., a return control), the user 102 may stop presenting the composite image 330 in the virtual environment 120, and, for example, representations of a group of virtual objects (such as the images 320-1, 320-2 and 320-3 shown in FIG. 3A) may be displayed again in the virtual environment 120 for the user 102 to select.

Alternatively or additionally, in the case that the composite image 330 is presented in the virtual environment 120, based on certain predetermined gesture instructions and/or voice instructions, a virtual scene in which the user 102 can purchase the object may be presented in the virtual environment 120 or a group of virtual objects may be presented again in the virtual environment 120 for the user 102 to select.

In an embodiment of the present disclosure, the user 102 may input instructions in the virtual environment 120 by a selection object, such as the first input, the second input, the third input and/or the selection of a first virtual object by the user 102 mentioned above. In some embodiments, the selection object may be an image of a real object in the real world (an image of the user's hand). In some other embodiments, the selection object may also be a virtual selection object corresponding to a physical object in the real world (e.g., a handle being operated by the user and/or the user's hand).

As shown in FIGS. 3A and 3B, a virtual selection object 303 is presented in the virtual environment 120 and may be a virtual object (e.g., a hand image) corresponding to the hand of a real user. In some embodiments, the user equipment 110 may also present a virtual ray emitted from the virtual selection object 303 as the origin in the virtual environment. If the user equipment detects that the virtual ray intersects with an object to be selected (a control or a virtual object, etc.) in the virtual environment 120, it is determined that the object is selected.

For example, an intersection of a virtual ray 304 and the control 322 is detected in FIG. 3A or an intersection of a virtual ray 305 and the control 333 is detected in FIG. 3B, the user equipment 110 determines that the control 322 or the control 333 is selected.

Through the scheme described in the above embodiments, users can implement behaviors that they usually perform in the real world in a virtual environment, which enriches the diversity of interaction processes that users can perform in the virtual environment and improves the user's interaction experience.

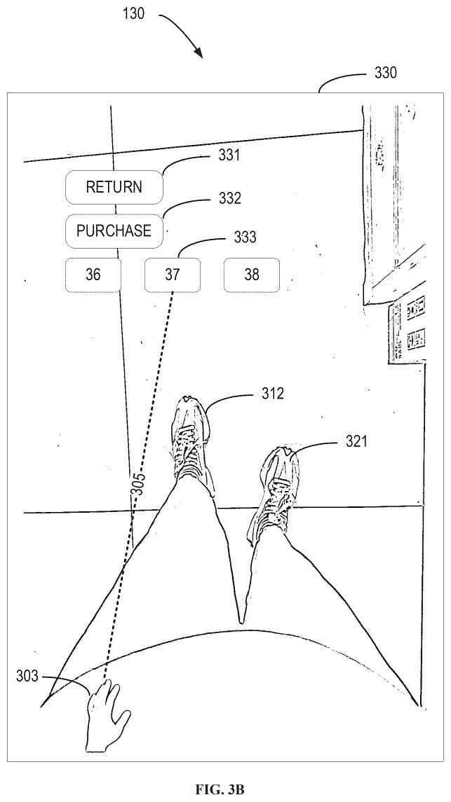

FIG. 4 shows a block diagram of an example interactive system in a virtual environment according to some embodiments of the present disclosure. In the particular embodiment of FIG. 4, interactive elements 420-1 to 420-M (where M is a positive integer greater than or equal to 1) correspond to representations of virtual objects (e.g., the images 320-1, 320-2, and 320-3) and/or virtual objects (e.g., the virtual object 321) and/or virtual controls (e.g., the virtual controls 322, 331, 332, and 333) suitable for presentation in the virtual environment, respectively. In this case, the control module displays the interactive elements 420-1 to 420-M in the virtual environment 120.

Next, how to detect a predetermined operation for a first virtual object/control will be described in detail in conjunction with FIG. 4.

In the particular embodiment of FIG. 4, multiple three-dimensional nodes and multiple components with specific functions are included. In addition, the interactive process discussed in the present disclosure can be driven and controlled by corresponding system logic.

As shown in FIG. 4, in some embodiments, each of the interactive elements 420 may have rendering components which defines rendering styles of virtual objects presented by the interactive element 420. At least one of the following data may be encapsulated in the rendering component: rendering data, rendering kit, rendering material, etc. In this way, the interactive elements 420 may be managed independently, and thus the system maintenance cost will be reduced.

Alternatively or additionally, in some embodiments, the interactive element 420 may also have a collision component configured to detect whether it is selected. In a particular embodiment, the control module may determine a spatial position of the interactive element 420 in the virtual environment 120, and further determine a collision range of the interactive element 420 based on the spatial position. When a collision signal is detected within the collision range, it is considered to be selected. For example, the user 102 may control the virtual ray of the virtual selection object to point to the predetermined collision range, and further determine the selection of the interactive element 420 by pressing a confirmation button or other operations.

Alternatively or additionally, in some embodiments, the interactive element 420 may further include a logic component, which is configured to implement the processing logic of the interactive element 420. In some embodiments, when the virtual ray points to the interactive element 420, the logic component may display multimedia information associated with the interactive element 420 in a manner such as animation. Further, as shown in FIGS. 3A and 3B, for example, when the image 320-1 is selected, the logic component may also assist in triggering the image composition of the virtual object 321 and the real object 312.

The particular embodiment of FIG. 4 further includes the user equipment 110. In some embodiments, the user equipment 110 can be implemented as a global universal interactive manipulation node. Further, the user equipment 110 can implement human-computer interaction in a virtual environment based on a three-dimensional model.

In some embodiments, the user equipment 110 may include a tracking component that can track the position and posture of an inertial measurement unit (IMU) of a physical selection object in real time, so that a virtual selection object (e.g., a virtual handle) in the virtual environment 120 can match a physical selection object (e.g., a real handle) in the real world.

Alternatively or additionally, the user equipment 110 may further include a current selection object model node. As shown in FIG. 4, the current selection object model node may have a rendering component that defines a rendering style of a current skin of a virtual manipulation node. At least one of the following data may be encapsulated in the rendering component: rendering data, rendering kit, rendering material, etc.

Alternatively or additionally, in some embodiments, the user equipment 110 may further include a current virtual ray node. The current virtual ray node may include a rendering component configured to draw a rendering style of the virtual ray of the current collision interaction. Alternatively or additionally, the current virtual ray node may further include a ray interaction component which may generate virtual ray data according to the tracking data, and cooperate with the collision component of the interactive element 420 to implement collision detection. Alternatively or additionally, the current virtual ray node may further include a logic component configured to execute processing logic such as updating the display length of the virtual ray according to the collision result.

In the particular embodiment of FIG. 4, the overall flow of the process of interaction with the interactive element 420 can be implemented by the control module. Specifically, the control module drives the ray interaction component of the user equipment 110 to perform collision detection with each collision component of the interactive element 420. If a first operation of the user 102 for the specific interactive element 420 is detected, the image composition of the virtual object and the real object is triggered. If a second operation of the user 102 for the specific interactive element 420 is detected, stopping presenting the image composition/rendering of the virtual object and the real object is triggered. If a third operation of the user 102 for the specific interactive element 420 is detected, the switching and updating of the representation of the virtual object presented in the virtual environment are triggered.

In some embodiments, the control module caches the rendering component of the current selection object model node and the rendering component of the current virtual ray node, and replaces the rendering component of the current selection object model node and/or the rendering component of the current virtual ray node with the rendering component of the interactive element 420.

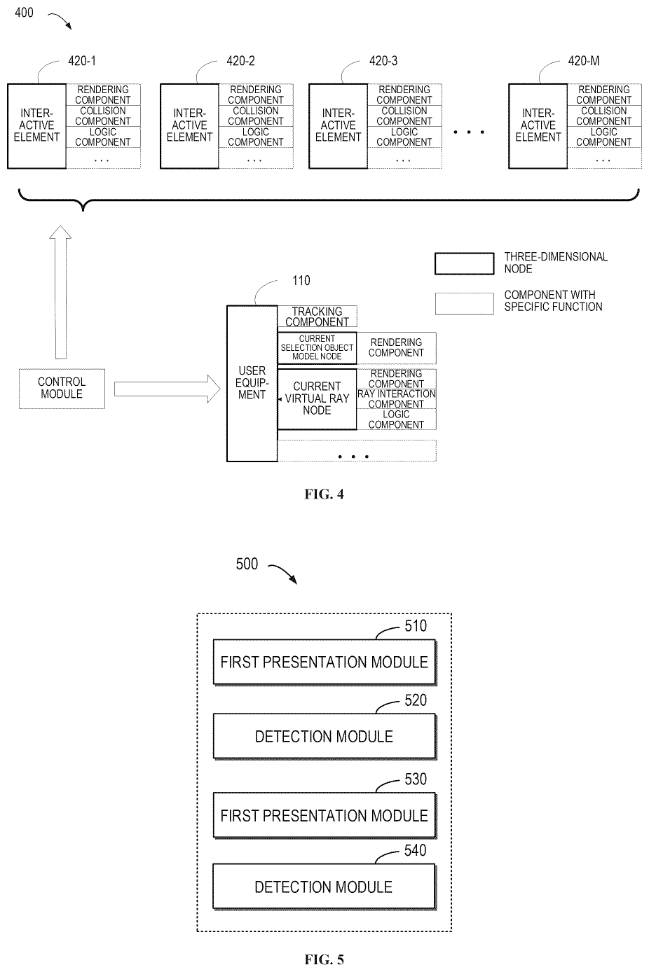

The embodiments of the present disclosure also provide a corresponding apparatus for implementing the above methods or processes. FIG. 5 shows a block diagram of an apparatus 500 for interaction in a virtual environment according to some embodiments of the present disclosure.

As shown in FIG. 5, the apparatus 500 includes a first presentation module 510 configured to present in the virtual environment: an image of a real object in a real world, and representations of a group of virtual objects, the representations including at least images of corresponding virtual objects.

In addition, the apparatus 500 further includes a detection module 520 configured to detect a selection, by a user, of a first virtual object from the group of virtual objects.

The apparatus 500 further includes a second presentation module 530 configured to present a composite image of the real object and the first virtual object in the virtual environment in response to detecting the selection.

In addition, the apparatus 500 further includes an association module 540 configured to associate the first virtual object with the user in response to receiving a first input from the user.

In some embodiments, the association module 540 can also be configured to present an access for associating the first virtual object with the user; and in response to receiving the first input via the access, present a virtual scene in which the user completes the association with the first virtual object, wherein completing the association at least includes enabling the user to become an owner of the first virtual object and/or the real object corresponding to the first virtual object.

In some embodiments, the apparatus 500 may be further configured to: in response to receiving a second input from the user, stop presenting the composite image; and display the representations of the group of virtual objects again for selection by the user.

In some embodiments, the apparatus 500 may also be configured to: in response to receiving a third input from the user, switch presentation positions of the representations of the group of virtual objects on an interface of the virtual environment for browsing by the user.

In some embodiments, the representations also include information about the corresponding virtual objects.

In some embodiments, the real object is a body part of the user, and the composite image represents a composite effect of the first virtual object being worn on the body part.

In some embodiments, the virtual environment further presents a selection object for selecting a function, wherein detecting the selection of the first virtual object includes detecting an intersection of a virtual ray associated with the selection object with the first virtual object in the virtual environment.

In some embodiments, the selection object is a virtual representation of a real object, or an image of the real object.

The modules included in the apparatus 500 can be implemented in various ways, including software, hardware, firmware, or any combination thereof. In some embodiments, one or more units can be implemented using software and/or firmware, such as machine-executable instructions stored in a storage medium. In addition to or as an alternative to machine-executable instructions, some or all of the modules in the apparatus 500 can be implemented at least in part by one or more hardware logic components. As an example and not limitation, exemplary types of hardware logic components that can be used include field programmable gate arrays (FPGAs), application specific integrated circuits (ASICs), application specific standard products (ASSPs), systems on chips (SOCs), complex programmable logic devices (CPLDs), and the like.

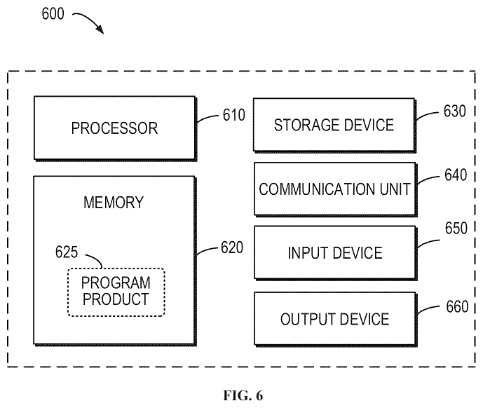

FIG. 6 shows a block diagram of an electronic device/server 600 in which one or more embodiments of the present disclosure may be implemented. The user equipment 110 of FIG. 1 may be implemented, for example, by the electronic device/server 600 shown in FIG. 6. It should be understood that the electronic device/server 600 shown in FIG. 6 is merely exemplary and should not constitute any limitation on the function and scope of the embodiments described herein.

As shown in FIG. 6, the electronic device/server 600 is in the form of a general electronic device. The components of the electronic device/server 600 may include, but are not limited to, one or more processors 610, a memory 620, a storage device 630, one or more communication units 640, one or more input devices 660, and one or more output devices 660. The processor 610 may be an actual or virtual processor and is capable of performing various processes according to a program stored in the memory 620. In a multi-processor system, multiple processors execute computer-executable instructions in parallel to improve the parallel processing capability of the electronic device/server 600.

The electronic device/server 600 typically includes a plurality of computer storage media. Such a medium may be any available medium accessible to the electronic device/server 600, including but not limited to volatile and non-volatile medium, removable and non-removable medium. The memory 620 may be a volatile memory (e.g., register, a cache, a random access memory (RAM)), a non-volatile memory (e.g., a read-only memory (ROM), an electrically erasable programmable read-only memory (EEPROM), a flash memory), or some combination thereof. The storage device 630 may be a removable or non-removable medium, and may include a machine-readable medium, such as a flash drive, a disk, or any other medium, which may be capable of being configured to store information and/or data (e.g., training data for training) and may be accessed within the electronic device/server 600.

The electronic device/server 600 may further include additional removable/non-removable, volatile/non-volatile storage media. Although not shown in FIG. 6, a disk drive for reading or writing from a removable, non-volatile disk (e.g., a “floppy disk”) and an optical drive for reading or writing from a removable, non-volatile optical disk may be provided. In these cases, each drive may be connected to a bus (not shown) by one or more data medium interfaces. The memory 620 may include a computer program product 625 having one or more program modules that are configured to perform various methods or actions of various embodiments of the present disclosure.

The communication unit 640 communicates with other electronic devices via a communication medium. Additionally, the functions of the components of the electronic device/server 600 can be implemented in a single computing cluster or multiple computing machines that can communicate via a communication connection. Therefore, the electronic device/server 600 can operate in a networked environment using a logical connection with one or more other servers, a network personal computer (PC), or another network node.

The input device 650 may be one or more input devices, such as a mouse, a keyboard, a tracking ball, etc. The output device 660 may be one or more output devices, such as a display, a speaker, a printer, etc. The electronic device/server 600 may also communicate with one or more external devices (not shown) such as a storage device, a display device, etc. through the communication unit 640 as needed, communicate with one or more devices that allow a user to interact with the electronic device/server 600, or communicate with any device (e.g., a network card, a modem, etc.) that allows the electronic device/server 600 to communicate with one or more other electronic devices. Such a communication may be performed via an input/output (I/O) interface (not shown).

According to an exemplary implementation of the present disclosure, a computer-readable storage medium is provided, in which one or more computer instructions are stored, wherein the one or more computer instructions are executed by a processor to implement the method described above.

Various aspects of the present disclosure are described herein with reference to the flowcharts and/or block diagrams of the method, apparatus (system) and computer program product implemented according to the present disclosure. It should be understood that each block of the flowcharts and/or block diagrams and combinations of various blocks in the flowcharts and/or block diagrams may be realized by computer-readable program instructions.

These computer-readable program instructions may be provided to the processor of a general-purpose computer, a special-purpose computer or other programmable data processing apparatus to produce a machine, so that these instructions, when executed by the processor of the computer or other programmable data processing apparatus, produce the apparatus implementing the functions/actions specified in one or more blocks in the flowcharts and/or block diagrams. These computer-readable program instructions may also be stored in a computer-readable storage medium, and these instructions enable the computer, the programmable data processing apparatus and/or other devices to work in a particular manner, so that the computer-readable medium having the instructions stored includes an article of manufacture including the instructions implementing various aspects of the functions/actions specified in one or more blocks in the flowcharts and/or block diagrams.

The computer-readable program instructions may be loaded onto the computer, other programmable data processing apparatuses, or other devices, such that a series of operation steps are executed on the computer, other programmable data processing apparatuses, or other devices to produce a computer-implemented process. Therefore, the instructions executed on the computer, other programmable data processing apparatuses, or other devices implement the functions/actions specified in one or more blocks in the flowcharts and/or block diagrams.

The flowcharts and block diagrams in the figures show possibly realized architectures, functions and operations of systems, methods and computer program products according to multiple embodiments of the present disclosure. In this regard, each block in the flowcharts or block diagrams may represent a module, a program segment or a part of instruction, and the module, the program segment or the part of instruction contains one or more executable instructions for realizing specified logical functions. In some alternative embodiments, the functions noted in the blocks may also occur in a different order than those noted in the figures. For example, two consecutive blocks may be actually executed substantially in parallel, and sometimes they may be executed in a reverse order, depending on the functions involved. It should also be noted that each block in the block diagrams and/or flowcharts and combinations of the blocks in the block diagrams and/or flowcharts may be realized by a dedicated hardware-based system executing specified functions or actions, or may be realized by a combination of dedicated hardware and computer instructions.

Various embodiments of the present disclosure have been described above, and the above descriptions are exemplary, are not exhaustive, and are not limited to the disclosed various embodiments. Many modifications and changes will be obvious to those ordinary skilled in the art without departing from the scope and spirit of the described various embodiments. The terminology used herein is chosen to best explain principles of various embodiments, practical application or improvement to technologies in the market, or to enable other ordinary skilled in the art to understand various embodiments disclosed herein.

1. A method for interaction in a virtual environment, comprising:
presenting in the virtual environment:
an image of a real object in a real world, and
representations of a group of virtual objects at least comprising images of corresponding virtual objects;
detecting a selection, by a user, of a first virtual object from the group of virtual objects;
in response to detecting the selection, presenting, in the virtual environment, a composite image of the real object and the first virtual object; and
in response to receiving a first input from the user, associating the first virtual object with the user.

2. The method of claim 1, wherein the associating comprises:
presenting an access for associating the first virtual object with the user; and
in response to receiving the first input via the access, presenting a virtual scene in which the user completes the association with the first virtual object, wherein completing the association at least comprises enabling the user to become an owner of the first virtual object and/or a real object corresponding to the first virtual object.

3. The method of claim 1, further comprising:
in response to receiving a second input from the user, stopping presenting the composite image; and
presenting the representations of the group of virtual objects again for selection by the user.

4. The method of claim 1, further comprising:
in response to receiving a third input from the user, switching presentation positions of the representations of the group of virtual objects on an interface of the virtual environment for browsing by the user.

5. The method of claim 1, wherein the representations further comprise information about the corresponding virtual objects.

6. The method of claim 1, wherein the real object is a body part of the user, and the composite image represents a composite effect of the first virtual object being worn on the body part.

7. The method of claim 1, wherein the virtual environment further presents a selection object for selecting a function, and wherein detecting the selection of the first virtual object comprises detecting an intersection of a virtual ray associated with the selection object with the first virtual object in the virtual environment.

8. The method of claim 7, wherein the selection object is a virtual representation of a real object, or an image of the real object.

9-18. (canceled)

19. at least one processor; and
at least one memory coupled to the at least one processor and storing instructions executed by the at least one processor, wherein the instructions, when executed by the at least one processor, cause the device to perform a method for interaction in a virtual environment, the method comprising:
presenting in the virtual environment:
an image of a real object in a real world, and
representations of a group of virtual objects, the representations comprising at least images of corresponding virtual objects;
detecting a selection, by a user, of a first virtual object from the group of virtual objects;
in response to detecting the selection, presenting, in the virtual environment, a composite image of the real object and the first virtual object; and
in response to receiving a first input from the user, associating the first virtual object with a user.

20. The electronic device of claim 19, wherein the associating comprises:
presenting an access for associating the first virtual object with the user; and
in response to receiving the first input via the access, presenting a virtual scene in which the user completes the association with the first virtual object, wherein completing the association at least comprises enabling the user to become an owner of the first virtual object and/or a real object corresponding to the first virtual object.

21. The electronic device of claim 19, further comprising:
in response to receiving a second input from the user, stopping presenting the composite image; and
presenting the representations of the group of virtual objects again for selection by the user.

22. The electronic device of claim 19, further comprising:
in response to receiving a third input from the user, switching presentation positions of the representations of the group of virtual objects on an interface of the virtual environment for browsing by the user.

23. The electronic device of claim 19, wherein the representations further comprise information about the corresponding virtual objects.

24. The electronic device of claim 19, wherein the real object is a body part of the user, and the composite image represents a composite effect of the first virtual object being worn on the body part.

25. The electronic device of claim 19, wherein the virtual environment further presents a selection object for selecting a function, and wherein detecting the selection of the first virtual object comprises detecting an intersection of a virtual ray associated with the selection object and the first virtual object in the virtual environment.

26. The electronic device of claim 25, wherein the selection object is a virtual representation of a real object, or an image of the real object.

27. A non-transitory computer-readable storage medium having stored thereon a computer program, wherein the computer program, when executed by a processor, implements a method comprising:
presenting in the virtual environment:
an image of a real object in a real world, and
representations of a group of virtual objects at least comprising images of corresponding virtual objects;
detecting a selection, by a user, of a first virtual object from the group of virtual objects;
in response to detecting the selection, presenting, in the virtual environment, a composite image of the real object and the first virtual object; and
in response to receiving a first input from the user, associating the first virtual object with the user.
